(19) United States
(12) Patent Application Publication
(10) Pub. No.: US 2010/0039203 A1
(43) Pub. Date: Feb. 18, 2010

(54) FILTER INDUCTOR ASSEMBLY

(75) Inventors: Jack ZHOU, Dong-Guan City (CN); F. NIU, Dong-Guan City (CN); C.S. KUNG, Taoyuan Hsien (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/428,098

(22) Filed: Apr. 22, 2009

(30) Foreign Application Priority Data
Aug. 15, 2008 (TW) 097214686

(51) Int. Cl. H01F 27/28

(52) U.S. Cl. 336/180

(57) ABSTRACT

A filter inductor assembly is provided. The filter inductor assembly of this invention comprises a magnetic body and a coil. The magnetic body has an even number of winding sections. The winding sections comprise a first section and a second section, while the second section is adjacent to the first section. The first coil is wound onto the first section on a surface of the magnetic body in a first direction, while the second coil is wound onto the second section on the surface of the magnetic body in a second direction, wherein the first direction is substantially opposite to the second direction. By using an even number of winding sections, the impedance frequency bandwidth of each winding section of the coil is increased. As a result, the filter inductance assembly can filter more electromagnetic interference than the prior art

This application claims priority to Taiwan Patent Application No. 097214686 filed on Aug. 15, 2008, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention provides a filter inductor assembly, and more particularly, provides a filter inductor assembly capable of effectively filtering electromagnetic interference (EMI).

2. Descriptions of the Related Art

Both economic developments and technological advancements have placed a higher demand on energy resources. Given the limited energy resources on Earth, more importance has been emphasized on the efficiency of energy resources. Thus, environmental protection and power-saving have become one of the prime objectives for design of most home appliances and electronic products currently available to increase the power utilization factor, the power supply ends of home appliances or power supply products are mostly provided with a power factor correction (PFC) function to reduce the input of irregular currents to make full use of the valuable energy resources by preventing wasted power in the power distribution system. In applications of the power supply ends or power supply products, filter inductors are used for power factor correction serve to improve the power factor by modulating the current waveform to compensate for the phase difference between the current and the voltage.

Because various home appliances and electronic products have been designed to have increasingly smaller profiles, electronic circuits within the power supply ends or power supply products are becoming denser and more complex. Meanwhile, this exacerbates electromagnetic interference (EMI) noises among the internal electronic components, causing interference to the normal operation of the product.

EMI noises are distinguished into two categories, conducted emission (CE) and radiated emission (RE). Currently, many EMI noises are mostly in the form of conducted emission in power supply ends or power supply products. When alternating current (AC) noises pass through the filter inductor, the inductance generated by the filter inductor assembly blocks the noises from passing therethrough. The formula of inductive reactance is generally represented as X_{L}=2πfL, where X_{L} represents the inductive reactance, L represents the inductance, and f represents the frequency. Because the power supply products and hence circuits thereof are gradually miniaturized, the power factor correction function and the filtering function are usually integrated into a single inductor in the industry.

A conventional filter inductor assembly 1 that integrates both the power factor correction function and the EMI filtering function is depicted in FIG. 1. The filter inductor assembly 1 comprises a magnetic body 11 and a coil 12. The coil 12 is wound onto a surface of the magnetic body 11 in a clockwise direction (or a counterclockwise direction). Here, the coil 12 is an enamelled wire formed of a metal core conductor coated with an insulating varnish.

The direction of current flow and magnetic field in the filter inductor assembly 1 are shown in FIG. 1B respectively. The coil 12 is wound onto the magnetic body 11 in the clockwise direction to form a magnetic field 13. Using Ampere's right-hand rule, the magnetic field induced by the coil current is directed into the paper. When an AC noise passes through the filter inductor assembly 1, an induction electromotive force in an opposite phase will be induced across the coil according to the Faraday's Law to smooth the waveform by inhibiting a sudden change in the current. The induction principle is well known and thus will not be further described herein.

With respect to electromagnetic compatibility (EMC), a number of international specifications have been established to specify the EMI limits of such products. This is intended to prevent the products from interfering with normal operations of other neighboring electronic products due to excessively high EMI and also to require that the products shall be provided with the EMI immunity.

According to the Electromagnetic Compatibility (EMC) standard (EN55022) established by the European Union (EU), the relevant specifications and limits on radiated emission and conducted emission for industrial information technology equipment (ITE) (A class) and home ITE (B class) are listed in Table 1 below, in which the Quasi-Peak (QP) value and the Average (AV) value of the conducted emission are also shown.

TABLE 1
Conduction

| | Category | | | |
|---|---|---|---|---|
| | A class | | B class | |
| | Range | | Range | |
| Frequency (MHz) | Limited (dBμV) | | Limited (dBμV) | |
| — | QP | AV | Q.P. | AV |
| 0.15~0.5 | 79 | 66 | 66~56 | 56~46 |
| 0.5~5 | 73 | 60 | 56 | 46 |
| 5~30 | 73 | 60 | 60 | 50 |

Here, this will be described with respect to the common home ITE (B class). Accordingly, based on Table 1 above, a testing standard graph for conducted emission of the common home ITE (B class) is shown in FIG. 2, where the longitudinal axis represents the electric field in dBμV and the horizontal axis represents the frequency in megahertz (MHz). It can be seen from this testing standard graph that the testing standard decreases linearly from 66 dBμV to 56 dBμV within the range of 0.15˜0.5 MHz, and remains constant at 56 dBμV within the range of 0.5˜5 MHz and constant at 60 dBμV within the range of 5˜30 MHz. It should be appreciated that in FIG. 2, each interval along the longitudinal axis is drawn to represent 10 dBμV/div, but intervals along the horizontal axis are drawn in the varied scale and only divided by particular frequencies.

According to the EMC standard established by EU, test results of the filter inductor assembly 1 in different frequency bands are shown in FIGS. 3A, 3B and 3C respectively. As compared to the standard graph shown in FIG. 2, the filter inductor assembly 1 demonstrates a seriously undersized filtering band and poor filtering effect.

Another conventional filter inductor assembly 4 is depicted in FIG. 4A. The filter inductor assembly 4 comprises a magnetic body 41, a first coil 42 and a second coil 43. As compared to the filter inductor assembly 1 shown in FIG. 1A, the filter inductor assembly 4 has the additional second coil 43. More specifically, the first coil 42 is wound onto the magnetic body 11 in the winding manner as shown in FIG. 1A, and then the second coil 43 is wound onto the magnetic body 41 in the same winding direction as the first coil 42 so that two layers of coils are provided on the magnetic body 41. The current flow direction and magnetic field direction in the filter inductor assembly 4 are shown in FIG. 4B respectively. With the coils 42, 43 wound on the magnetic body 41, a magnetic field 44 is generated. Using Ampere's right-hand rule, the magnetic field induced by the coil currents is directed into the paper. Also, it can be known from the Faraday's Law that induced voltages across the coils are in direct proportion to the rate of change in the magnetic flux (i.e., change in magnetic flux in a unit time). These are well known and thus will not be further described herein.

According to the EMC standard established by EU, the test results of the filter inductor assembly 4 in different frequency bands are shown in FIGS. 5A, 5B and 5C respectively. As compared to the test results of the filter inductor assembly 1 shown in FIGS. 3A, 3B and 3C, the filter inductor assembly 4 demonstrates slightly poorer performance in the low frequency band (0.15˜0.5 MHz) and much poorer performance in the other frequency bands (0.5˜5 MHz and 5˜30 MHz) than the filter inductor assembly 1. Therefore, the filter inductor assembly 4, although consumes an additional coil, is completely unable to address the problem of undersized filtering frequency-band with the filter inductor assembly 1.

Accordingly, because the filter inductor assemblies of the prior art not only have a seriously undersized filtering frequency bandwidth, but are also unable to deliver adequate EMI filtering effect, EMI still occurs in operation of the power supply products. In view of this, an urgent need still remains in the art to effectively mitigate the EMI in operation of the power supply products.

### SUMMARY OF THE INVENTION

One primary objective of this invention is to provide a filter inductor assembly. The filter inductor assembly of this invention can not only correct the power factor, but also mitigate the EMI effectively with a simpler structure and at a lower cost.

The filter inductor assembly of this invention comprises a magnetic body and a coil. The magnetic body has an even number of winding sections, including a first section and a second section that is adjacent to the first section. The first coil is wound onto the first section on the surface of the magnetic body in the first direction, while the second coil is wound onto the second section on the surface of the magnetic body in the second direction that is substantially adverse to the second direction.

According to this invention, the single winding section in the prior art is replaced by the even number of winding sections. In this way, the impedance frequency bandwidth of the coil in every winding section is remarkably increased to filter much more EMI than the prior art filter inductor assembly.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of the filter inductor assembly of the prior art;

FIG. 1B is a schematic view illustrating a magnetic field of the prior art filter inductor assembly;

FIG. 2 is a schematic graph illustrating the relevant specifications and limits on the conducted emission in the EMC standard established by the EU;

FIGS. 3A, 3B, 3C are schematic views illustrating test results of the prior art filter inductor assembly in different frequency ranges respectively;

FIG. 4A is a schematic view of another filter inductor assembly of the prior art;

FIG. 4B is a schematic view illustrating a magnetic field of another filter inductor assembly of the prior art;

FIGS. 5A, 5B, 5C are schematic views illustrating test results of another filter inductor assembly of the prior art in different frequency ranges respectively;

FIG. 6A is a schematic view of a filter inductor assembly according to the first embodiment of this invention;

FIG. 6B is a schematic view illustrating a magnetic field of the filter inductor assembly according to the first embodiment of this invention;

FIGS. 7A, 7B are schematic views illustrating test results of the filter inductor assembly of this invention in different frequency ranges respectively;

FIG. 8A is a schematic view of a filter inductor assembly according to the second embodiment of this invention; and

FIG. 8B is a schematic view illustrating a magnetic field of the filter inductor assembly according to the second embodiment of this invention.

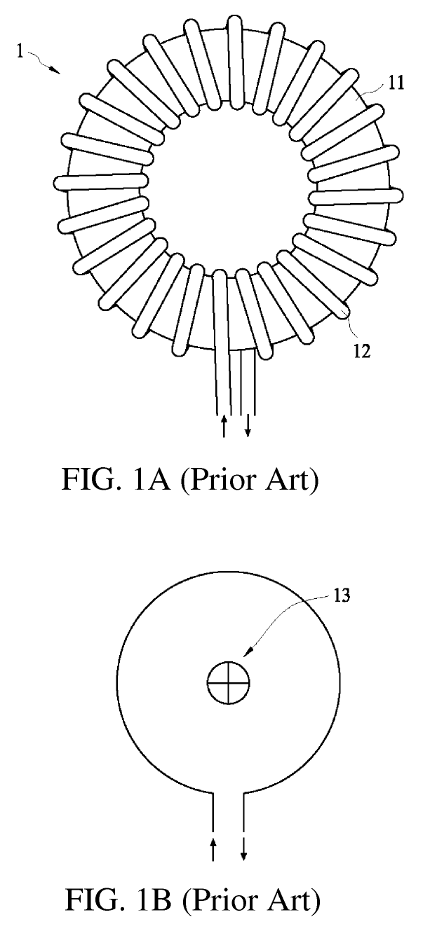

### DESCRIPTION OF THE PREFERRED EMBODIMENT

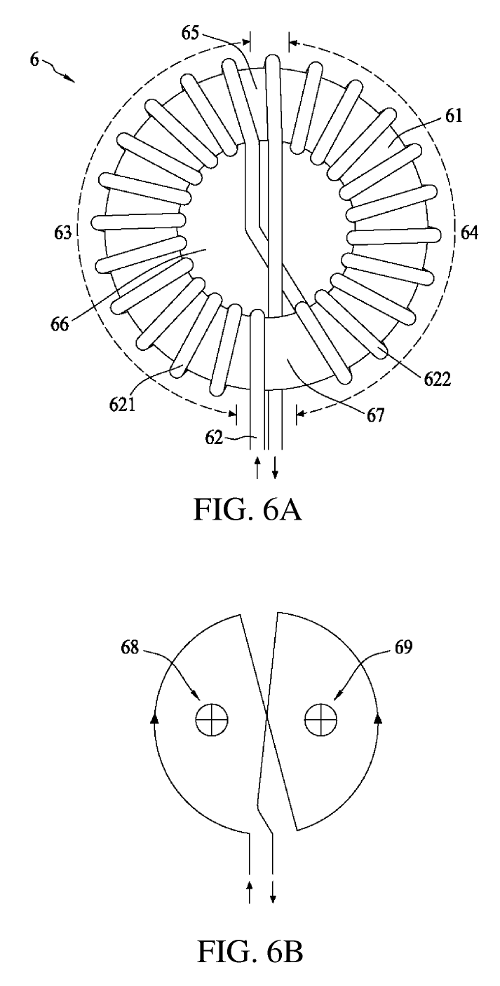

FIG. 6A depicts the first embodiment of this invention, which is a filter inductor assembly 6 for use in a power supply product. The filter inductor assembly 6 of this invention comprises a magnetic body 61 and a coil 62. The coil 62 comprises a first coil 621 and a second coil 622. It should be appreciated that although the magnetic body 61 of the filter inductor assembly 6 is shaped into a ring in this embodiment, it is not merely limited thereto. In other examples, the magnetic body 61 may also be shaped into a circle, a rectangle, a triangle, an ellipse or a diamond provided that it is in a regular form.

The magnetic body 61 has a hollow portion 66 and an even number of winding sections. In this embodiment, the magnetic body 61 has two winding sections in total, including a first section 63 and a second section 64 that is adjacent to the first section 63. In this embodiment, the first section 63 has a length equal to that of the second section 64 so that the magnetic forces of the two sections are equivalent. In locations where the first section 63 adjoins the second section 64, a first adjoining site 65 and second adjoining site 67 are defined.

The first coil 621, which may take any point on the magnetic body 61 as a starting point, is wound onto the first section 63 on a surface of the magnetic body 61 in a first direction. When it is wound up to the first adjoining site 65 where the first section 63 meets the second section 64, the first coil 621 is led through the hollow portion 66 of the magnetic body 61 to the other meeting point of the first section 63 and the second section 64, i.e. the second adjoining site 67. Then, the second coil 622 is further wound onto the second section 64 on the surface of the magnetic body 61 in a second direction. When the second coil 622 is wound up to the first adjoining site 65 where the first section 63 meets the second section 64, the second coil 622 is again led through the hollow portion 66 back to the second adjoining site 67 to form a leading-out terminal.

It should be noted that the first direction and the second direction are substantially adverse to each other. More specifically, in this embodiment, the first direction is a clockwise direction while the second direction is a counterclockwise direction. In other examples, however, based on the design idea where the directions are reversed, the first direction may be in the counterclockwise direction while the second direction is the clockwise direction instead.

Additionally, as shown in FIG. 6A, the number of turns of the first coil 621 wound onto the first section 63 is substantially equal to that of the second coil 622 wound onto the second section 63 also to obtain equivalent absolute magnetic forces in each of the sections. Furthermore, in this embodiment, the coil 62 is a metal wire made of a material selected from the group of Cu, Al, Au, Ag, Fe, Cr, Pd, W, Ni and Pt. However, the materials set forth herein are only for purposes of illustration, and any conductive metal materials may be used in this embodiment for electric conduction purposes.

In this embodiment, the directions of the current flow and magnetic fields in the filter inductor assembly 6 are depicted in FIG. 6B. Because the coil 62 is wound onto the first section 63 and the second section 64 in different directions respectively, the first coil 621 wound in the first direction forms in the first section 63 to form a first magnetic field 68 directed into the paper, and the second coil 622 wound in the second direction forms in the second section 64 to form a second magnetic field 69 also directed into the paper. It should be noted that in this embodiment, the first section 63 and the second section 64 are opposite to each other in terms of both the directions in which the first coil 621 and the second coil 622 are wound and the current flow directions. Using Ampere's right hand rule, both the first magnetic field 68 and the second magnetic field 69 are directed into the paper.

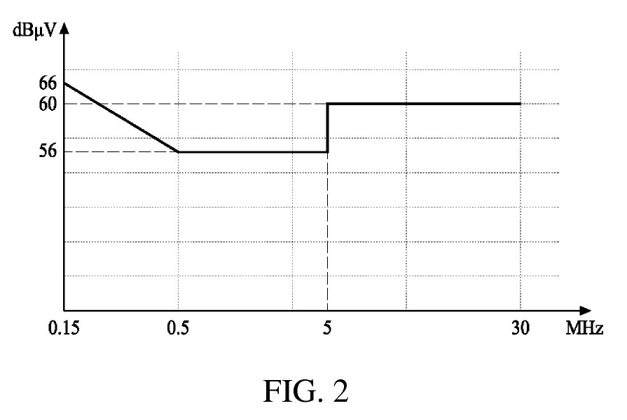

To further illustrate the EMI filtering effect of this invention, a schematic view illustrating the EMC standard (EN55022) established by the EU is depicted in FIG. 2. For the information technology equipment (ITE) of the B class, relevant specifications and limits on conducted emission are listed in Table 1, in which the Quasi-Peak (QP) value and the Average (AV) value of the conducted emission are also shown.

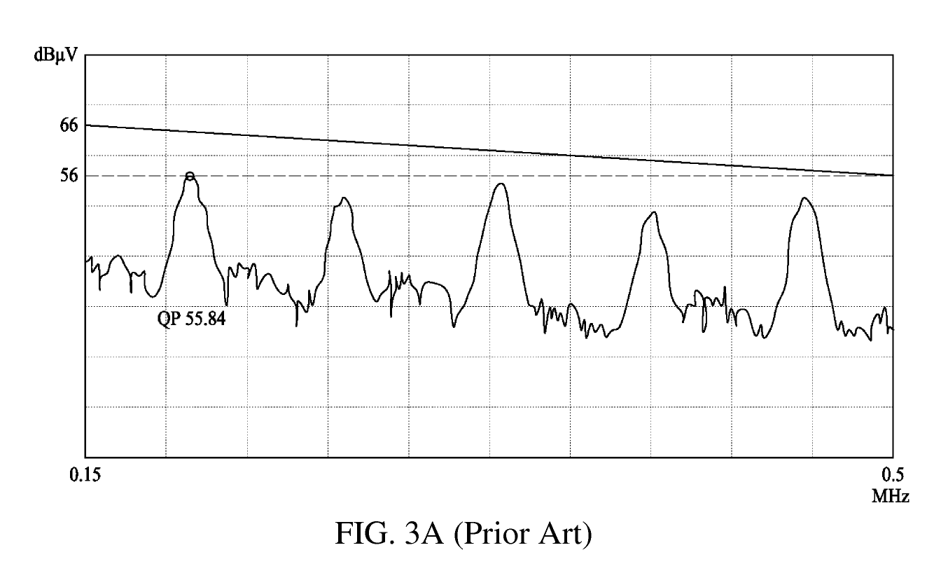

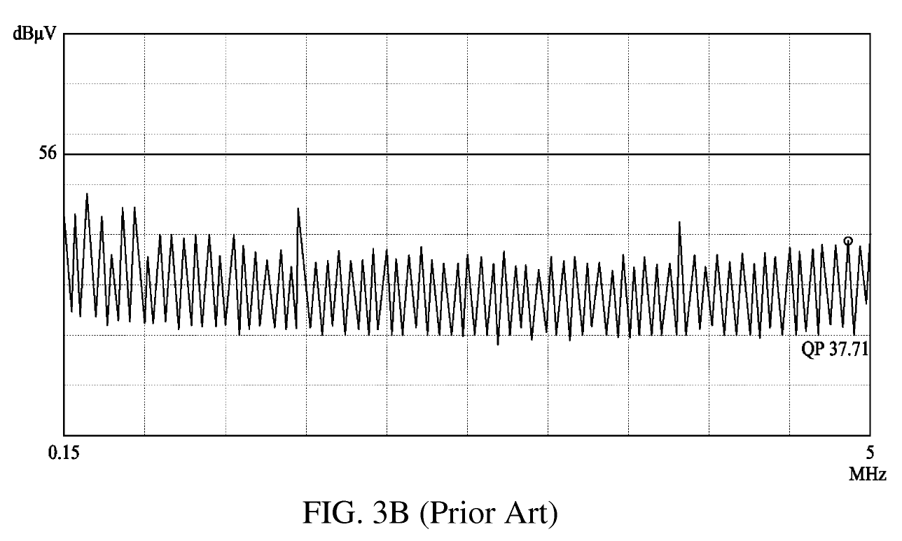

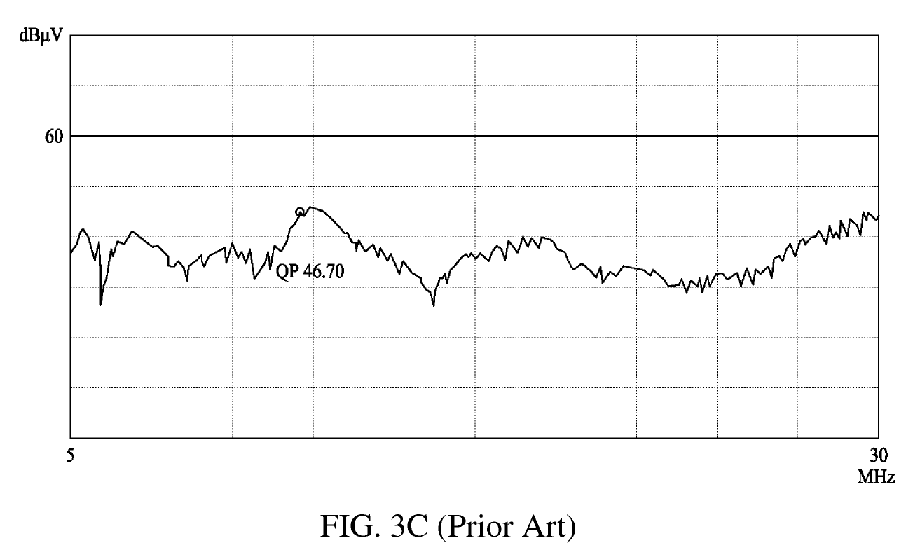

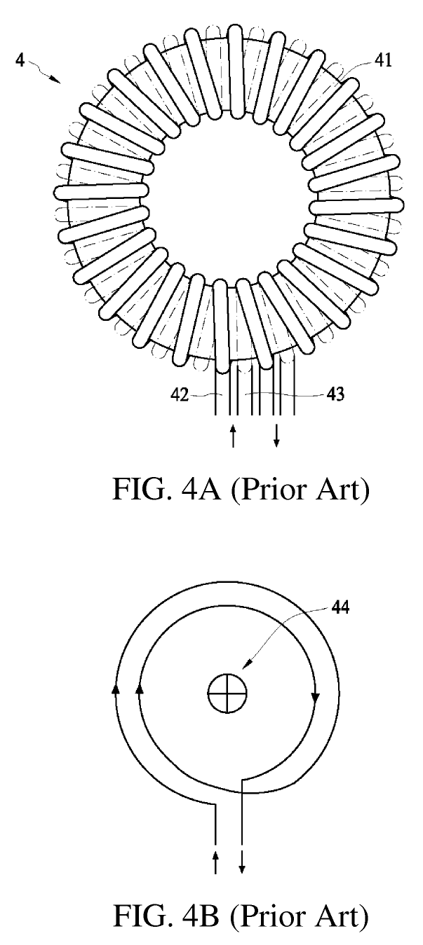

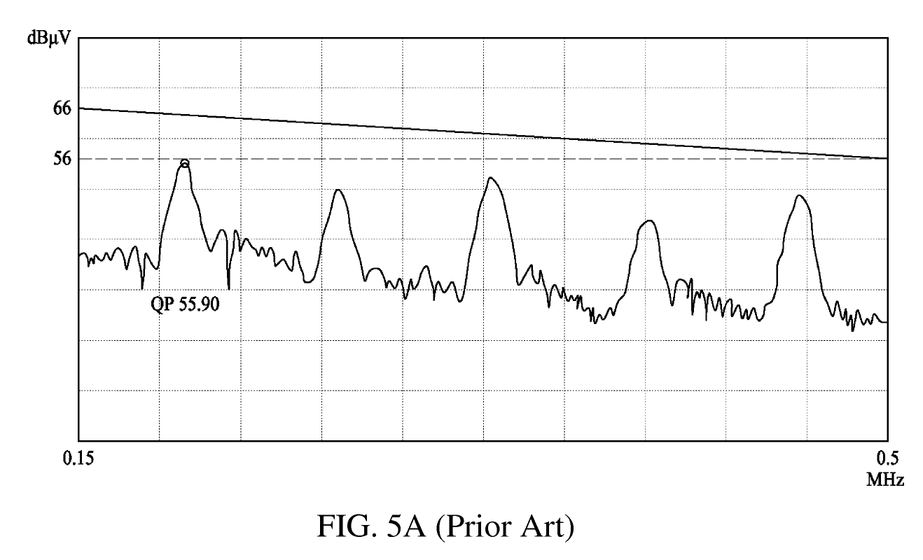

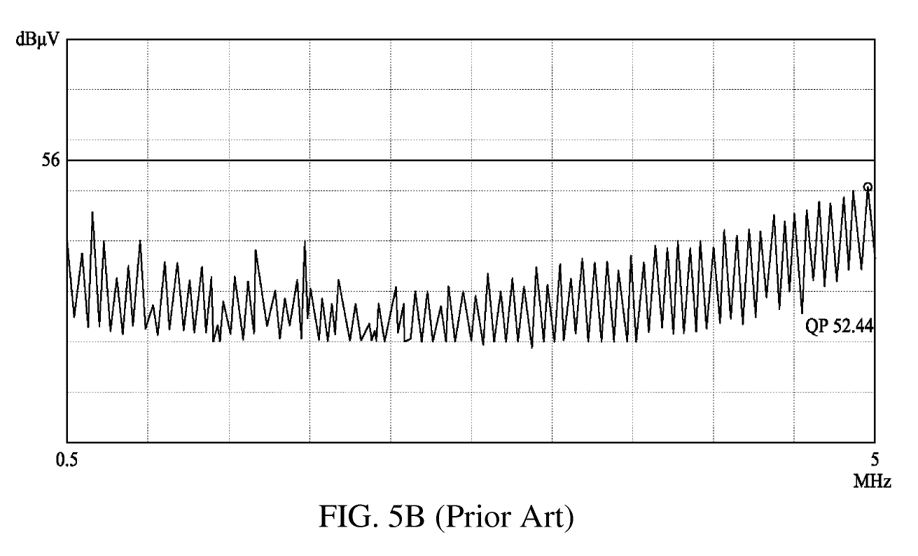

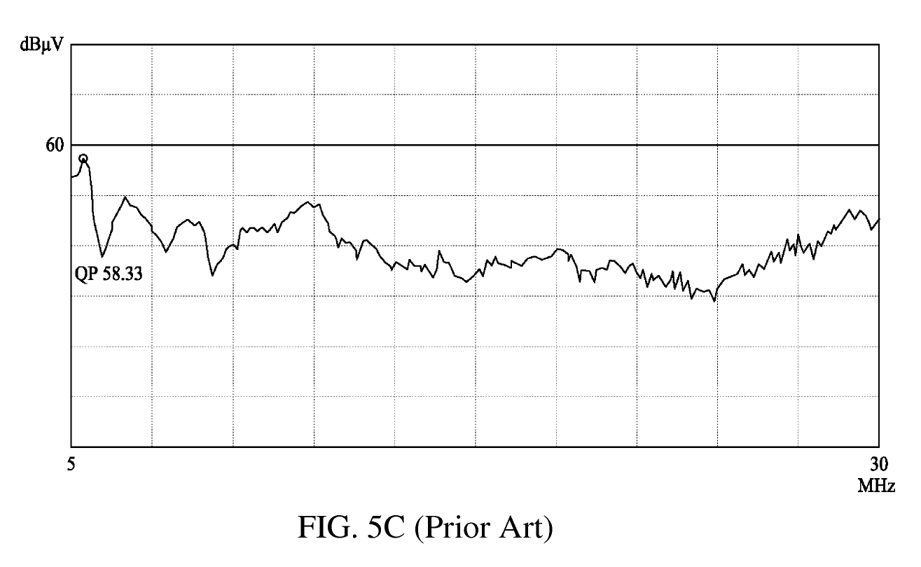

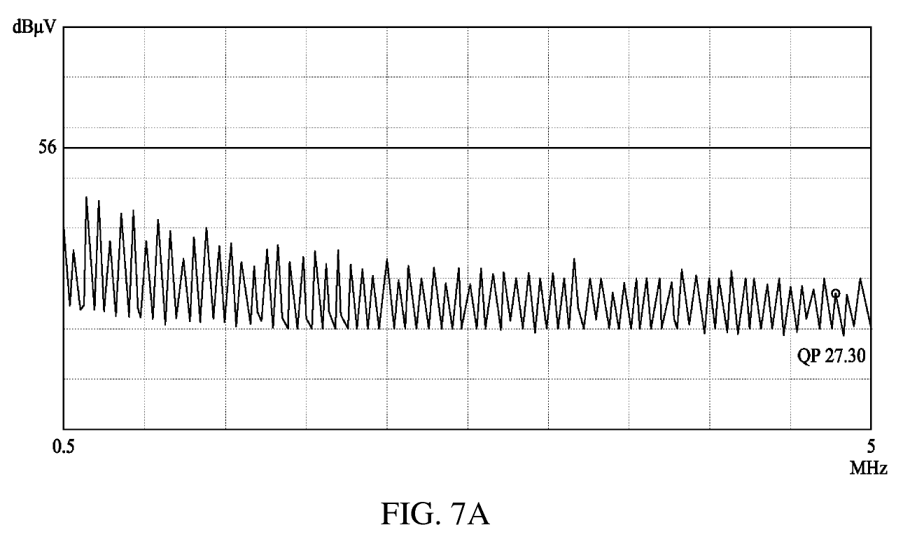

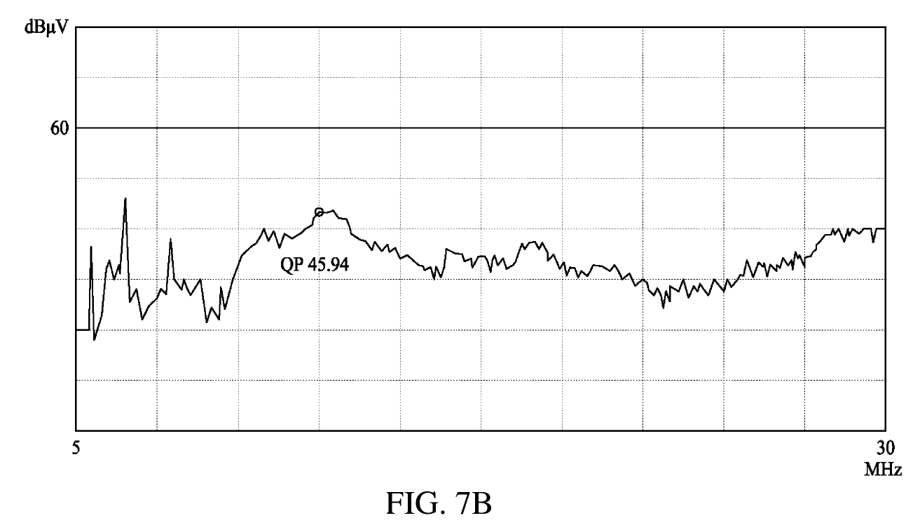

The filter inductor assembly 6 of this invention is tested according to the standard shown in FIG. 2, and test results of the filter inductor assembly 6 in the frequency bands of 0.5˜5 MHz and 5˜30 MHz are illustrated in FIGS. 7A and 7B respectively. It should be noted that the filter inductor assembly 6 delivers a filtering effect similar to those of the filter inductor assembly 1 of the prior art and the filter inductor assembly 4 of the prior art in the low frequency band (0.15˜0.5 MHz) as shown in FIGS. 3A and 5A. The test values thereof make little difference, so the test results in this frequency band will not be described again herein. Hereinafter, the test results of the filter inductor assembly 6 in the frequency bands of 0.5˜5 MHz and 5˜30 MHz will be compared with those of the prior art filter inductor assembly 1 and the prior art filter inductor assembly 4 to further illustrate the filtering effect of this invention.

The EMI test results of the filter inductor assemblies 1, 4 and 6 in the frequency band of 0.5˜5 MHz will first be compared with reference to FIGS. 3B, 5B and 7A. In this frequency band, the filter inductor assembly 6 of this invention exhibits a Q.P. value of 27.30 dBμV as shown in FIG. 7A. The filter inductor assembly 1 of the prior art exhibits a Q.P. value of 37.71 dBμV as shown in FIG. 3B, while the other filter inductor assembly 4 of the prior art exhibits a Q.P. value of 52.44 dBμV as shown in FIG. 5B. Provided that the Q.P. value is smaller than the limit of 56 dBμV specified for this frequency band in the standard, the larger the difference between the Q.P. value and the standard limit, the better the effect. In the frequency band of 0.5˜5 MHz, the difference values for the filter inductor assemblies 1, 4, 6 are 18.29 dBμV, 3.56 dBμV and 28.7 dBμV respectively. Obviously, the test value of the filter inductor assembly 6 exhibits the largest difference from the standard limit among the three test values, so the filter inductor assembly 6 of this invention is capable of reducing the EMI of products significantly in the frequency band of 0.5˜5 MHz.

Next, the EMI test results of the filter inductor assemblies 1, 4 and 6 in the frequency band of 5˜30 MHz will be compared with reference to FIGS. 3C, 5C and 7B. In this frequency band, the filter inductor assembly 6 of this invention exhibits a Q.P. value of 45.94 dBμV as shown in FIG. 7B. The filter inductor assembly 1 of the prior art exhibits a Q.P. value of 46.70 dBμV as shown in FIG. 3C, while the other filter inductor assembly 4 of the prior art exhibits a Q.P. value of 58.33 dBμV as shown in FIG. 5C. Provided that the Q.P. value is smaller than the limit of 60 dBμV specified for this frequency band in the standard, the larger the difference between the Q.P. value and the standard limit, the better the effect. In the frequency band of 5˜30 MHz, the difference values for the filter inductor assemblies 1, 4, 6 are 13.30 dBμV, 1.67 dBμV and 14.06 dBμV respectively. The test value of the filter inductor assembly 6 exhibits the largest difference from the standard limit among the three test values, so the filter inductor assembly 6 of this invention is capable of reducing the EMI of products significantly in the frequency band of 5˜30 MHz. Because a larger difference from the standard limit will deliver a better effect and the test value of the filter inductor assembly 6 has the largest difference among the three test values, the filter inductor assembly 6 will have the lowest EMI.

The frequency values cited above, which are standard values specified by EU, are only provided herein for purposes of illustration. In addition, the filtering frequency bands of the filter inductor assembly of this invention are also not limited. It can be seen from the above experimental data that the filter inductor assembly of this invention can surely reduce the EMI remarkably as compared to the filter inductor assemblies of the prior art. For ease of understanding, a filter inductor assembly with four winding sections will be further illustrated in the following description. However, it shall be noted that the filter inductor assembly of this invention is not limited to two or four winding sections. Rather, all filter inductor assemblies with any even number of winding sections that have adjacent sections wound in opposite directions to generate opposite magnetic fields fall within the basic concept and spirit of this invention.

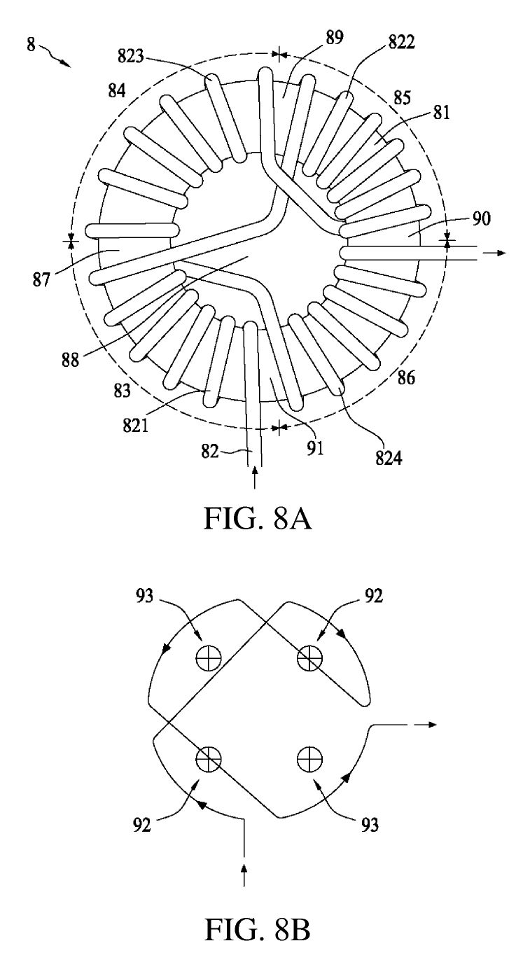

FIG. 8A illustrates the second embodiment of the filter inductor assembly of this invention. In this embodiment, the filter inductor assembly 8, which is also for use in a power supply product, comprises a magnetic body 81 and a coil 82. The coil 82 comprises a first coil 821, a second coil 822, a third coil 823 and a fourth coil 824. Although the magnetic body 81 of the filter inductor assembly 8 is shaped into a ring in this embodiment, it is not merely limited thereto this arrangement. In other examples, the magnetic body 81 may also be shaped into a circle, a rectangle, a triangle, an ellipse or a diamond provided that it is in a regular form.

The magnetic body 81 has a hollow portion 88 and an even number of winding sections. In this embodiment, the magnetic body 81 has four winding sections in total, including a first section 83, a second section 84, a third section 85 and a fourth section 86. The second section 84 is adjacent to both the first section 83 and the third section 85, while the third section 85 is adjacent to both the second section 84 and the fourth section 86. In addition, the fourth section 86 is located between the third section 85 and the first section 83. In this embodiment, the first section 83, the second section 84, the third section 85 and the fourth section 86 all have the same length so that the magnetic forces of the four sections are equivalent. A first adjoining site 87 is defined at the location where the first section 83 adjoins the second section 84, while a second adjoining site 89 is defined at the location where the second section 84 adjoins the third section 85. In addition, a third adjoining site 90 is defined at the location where the third section 85 adjoins the fourth section 86, while a fourth adjoining site 91 is defined at the location where the fourth section 86 adjoins the first section 83.

A first coil 821, which may take any point on the magnetic body 81 as a starting point, is wound onto the first section 83 on a surface of the magnetic body 81 in a first direction. When the coil is wound up to the first adjoining site 87 where the first section 83 meets the second section 84, the first coil 821 is led through the hollow portion 88 of the magnetic body 81 to the second adjoining site 89 where the second section 84 meets the third section 85. Then, the second coil 822 is further wound onto the third section 85 on the surface of the magnetic body 81 in the first direction.

When the second coil 822 is wound up on the third adjoining site 90 where the third section 85 meets the fourth section 86, the second coil 822 is again led through the hollow portion 88 back to the second adjoining site 89 where the second section 84 meets the third section 85. Then, the third coil 823 is wound onto the second section 84 on a surface of the magnetic body 81 in a second direction instead. When the coil is wound up on the first adjoining site 87 where the first section 83 meets the second section 84, the third coil 823 is again led through the hollow portion 88 of the magnetic body 81 to the fourth adjoining site 91 where the first section 83 meets the fourth section 86. Then, the fourth coil 824 is further wound onto the fourth section 86 on the surface of the magnetic body 81 in the second direction. When the fourth coil 824 is wound on the third adjoining site 90 where the third section 85 meets the fourth section 86, the fourth coil 824 is led out to form a leading-out terminal, thus completing the winding process.

More specifically, the first direction and the second direction of the coil 82 are substantially adverse to each other. Particularly, in this embodiment, the first direction is clockwise while the second direction is counterclockwise. In other examples, however, based on the design idea where the directions are reversed, the first direction may be counterclockwise while the second direction is clockwise.

Additionally, as shown in FIG. 8A, the coil 82 is wound onto each of the sections in a substantially equal number of turns to obtain equivalent absolute magnetic forces in each of the sections. Furthermore, in this embodiment, the coil 82 is a metal wire made of a material selected from the group of Cu, Al, Au, Ag, Fe, Cr, Pd, W, Ni and Pt. However, the materials set forth herein are only for purposes of illustration, and any conductive metal materials may be used in this embodiment for electric conduction purposes.

It should be appreciated that the four-section scheme shown in FIG. 8 in this embodiment is only provided for illustration, and in practice, any even number of winding sections may be used in this invention. Additionally, the winding sequence is not limited to what is described above, and other sequences may occur to those skilled in the art. For instance, the winding process may be done in the sequence of the first section 83, the second section 84, the third section 85 and the fourth section 86, or in the sequence of the first section 83, the fourth section 86, the second section 84 and the third section 85.

In this embodiment, the direction of the current flow and magnetic field direction of the filter inductor assembly 8 are depicted in FIG. 8B. Because the coil 82 is wound onto the first section 83 and the second section 84 in different directions respectively, the coil 82 wound onto the first section 83 in the first direction and the coil 82 wound onto the third section 85 in the first direction form two first magnetic fields 92 according to Ampere's right-hand rule, while the coil 82 wound onto the second section 84 in the second direction and the coil 82 wound onto the fourth section 86 in the second direction form two second magnetic fields 93. The two magnetic fields going in the same direction are adapted to enhance the EMI filtering effect. In particular, the first magnetic field 92 and the second magnetic field 93 are opposite each other in terms of both the winding directions and the current flow directions. Using Ampere's right hand rule, both the first magnetic field 92 and the second magnetic field 93 are directed into the paper. Because the magnetic fields are in the same direction and the number of magnetic fields is increased, EMI filtering can be enhanced. The number of magnetic fields in this embodiment is twice that of the first embodiment, so the filter inductor assembly 8 delivers an EMI filtering effect much better than that of the filter inductor assembly 6.

This invention reduces capacitance values between the wires by dividing the magnetic body into a plurality of winding sections. The capacitive reactance generated by the filter inductor assembly is generally represented by the formula, Xc=1/2πfc, where Xc represents the capacitive reactance, c represents the capacitance value and f represents the frequency. To maintain a constant capacitive reactance value, the smaller the capacitance value, the larger the frequency (f) taken, which represents substantial improvement of the impedance frequency bandwidth. Furthermore, because the capacitance values between the wires are reduced by dividing the magnetic body into a plurality of winding sections, the capacitive reactance is increased and, consequently, the capability of the filter inductor assembly to prevent noises improves.

As compared to the prior art, this invention filters more EMI than solutions of the prior art. As a result, it is possible to prolong the service life of the power supply product adopting the filter inductor assembly of this invention and avoid interference with the operation and service life of other neighboring appliances.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A filter inductor assembly, comprising:
a magnetic body, having an even number of winding sections, the winding sections comprising a first section and a second section, the second section being adjacent to the first section; and
a coil, having a first coil and a second coil, the first coil wound onto the first section on a surface of the magnetic body in a first direction, the second coil wound onto the second section on the surface of the magnetic body in a second direction, wherein the first direction is substantially adverse to the second direction, and the first direction is one of a clockwise direction and a counter-clockwise direction, and the second direction is another direction of the counter-clockwise direction and the clockwise direction.

2. The filter inductor assembly as claimed in claim 1, wherein the number of turns of the first coil wound onto the first section is substantially equal to the number of turns of the second coil wound onto winding the second section.

3. The filter inductor assembly as claimed in claim 1, wherein the winding sections further comprises a third section and a fourth section, and the third section is adjacent to the second section, and the fourth section is located between the third section and the first section, and a third coil winds onto the third section in the first direction and a fourth coil winds onto the fourth section in the section direction.

4. The filter inductor assembly as claimed in claim 1, wherein the numbers of turns of the coil on the winding sections are substantially the same.

5. The filter inductor assembly as claimed in claim 4, wherein the magnetic body has a shape selected from a circle, a ring, a rectangle, a triangle, an ellipse or a diamond.

6. The filter inductor assembly as claimed in claim 1, wherein the coil is a metal wire.
